(19) United States
(12) Patent Application Publication
(10) Pub. No.: US 2018/0260884 A1
(43) Pub. Date: Sep. 13, 2018

(54) METHOD AND SYSTEM FOR LOCATION-BASED PRODUCT MERCHANDISING

(71) Applicant: RADIUS8, INC., Princeton, NJ (US)

(72) Inventors: SANDEEP BHANOTE, MONROE TOWNSHIP, NJ (US); BRENDAN PHELAN, PRINCETON, NJ (US); EVEN SHAW, PRINCETON, NJ (US)

(21) Appl. No.: 15/916,848

(22) Filed: Mar. 9, 2018

Related U.S. Application Data
(60) Provisional application No. 62/469,654, filed on Mar. 10, 2017.

(51) Int. Cl. G06Q 30/06; G06Q 30/02; G06Q 10/08

(52) U.S. Cl. CPC G06Q 30/0639; G06Q 30/0643; G06Q 10/087; G06Q 30/0201; G06Q 30/0205

(57) ABSTRACT

A system includes a server performing a plurality of actions corresponding with a method for location-based product merchandising. The system includes a smart-type rules engine and receives a number of signals including inventory data, weather data, social media data, and events data and correlates all of the signals with a query from a user device relating to one or more physical stores or relating to a good or a service available from the one or more physical stores. The system determines the location of the user device and, together with the signals and the query, determines a geobased dataset of goods or services available at specific physical stores, and presents a product-based display element, such as a smart bar or a product display page reserve widget, on a user interface of the user device.

### CROSS REFERENCE TO RELATED APPLICATION

This Utility Patent Application claims the benefit of U.S. Provisional Patent Application Ser. No. 62/469,654 filed Mar. 10, 2017 entitled “METHOD AND APPARATUS FOR PROVIDING PRODUCT MERCHANDISING ON A WEBPAGE AND MOBILE DEVICE BASED ON GEOLOCATION BASED INFORMATION PATTERNS INCLUDING RETAIL PRODUCT INVENTORY, CONSUMER GEOLOCATION, WEATHER, AND EVENTS” which is hereby incorporated by reference in its entirety.

### BACKGROUND

Retailers operating physical stores commonly employ computerized inventory management systems to keep track of goods or services available at physical stores. Access to and use of inventory data stored in such computerized inventory management systems is generally limited to operators of the physical stores for logistics and management purposes such as analysis of store performance. Direct use of inventory data by consumers is limited today to systems that allow a consumer to “buy online, and pick up in-store.” Such in-store pickup experiences available today require manual inspection in-store and direct communications with store associates via phone or e-mail. Current attempts to deliver meaningful store experiences online are disjointed and confusing, failing to meet customer expectation for pre-shopping journey. This has resulted in loss of sales, degradation of customer sentiment, and erosion of market share.

Furthermore, merchandising systems available today fail to provide an online equivalent to the guiding assistance of an in-store sales associate to help a consumer find what products they want to buy or to provide the social cues a customer might receive when shopping for an item in a physical store such as the current weather, popular events taking place nearby, or what other shoppers are engaging with. In short, there exists a need for an automatic system and method of merchandising product inventory that is locally available based on consumer geolocation. There also exists a need for methodologies for curating this information based on local information patterns to provide an enhanced consumer experience which heretofore not been met or resolved. In other words, there exists a need for a system that enables retailers to sell more to consumers by creating store-centric online experiences, and in-store experiences based on local digital demand.

### SUMMARY

A system and method for location-based product merchandising are provided. The method includes the steps of receiving a query from a user device presenting a user interface, with the query relating to the one or more physical stores or relating to a good or a service available from the one or more physical stores. The method also includes determining a location of the user device; and determining the nearest ones of the physical stores to the location of the user device.

The method proceeds with the step of determining, using the location of the user device, a geobased dataset of goods or services currently available from at least one of the nearest ones of the physical stores to the location of the user device or from a selected one of the physical stores selected on the user device. The method also includes generating a product-based display element using the geobased dataset of goods or services associated with one or more of the nearest ones of the physical stores to the location of the user device or with the selected one of the physical stores. The method further includes presenting the product-based display element on the user interface of the user device.

The system includes one or more computer-readable storage media storing computer-executable executable instructions that, when executed by one or more processors, instruct a computing device to perform actions of the method described above. The system may also processes a number of different signals by the smart-type rules engine to more effectively promote sales of goods or services in physical stores based on geographic locations associated with the signals, the stores, and/or the user devices.

The system and method of the present disclosure has been shown to provide several advantages over systems of the prior art. Geographically targeted marketing of promoted goods and services, combined with signals processed by the smart-type rules engine, allows for significant improvements in the associated metrics, which translates to greater sales and greater profitability for the physical stores.

### BRIEF DESCRIPTION OF THE DRAWINGS

Further details, features and advantages of designs of the invention result from the following description of embodiment examples in reference to the associated drawings/figures.

FIG. 1 is a 4-quadrant diagram of different merchandising strategies;

FIG. 2 is a block diagram of an example system for location-based product merchandising;

FIG. 3 is a block diagram showing components of an example system for location-based product merchandising;

FIG. 4 is a block diagram showing details of location determination in the example system for location-based product merchandising;

FIG. 5 is a block diagram showing details of modules for determining a geobased dataset of goods or services in the example system for location-based product merchandising;

FIG. 6 is a block diagram showing various plugin modules in the example system for location-based product merchandising;

FIG. 7 is a block diagram showing details in a process of importing product data into the example system for location-based product merchandising;

FIG. 8 is a block diagram showing details in a process of importing product data into the example system for location-based product merchandising;

FIG. 9 is a block diagram showing details of a user interface module in the example system for location-based product merchandising;

FIG. 10A is an example of a user interface screen on a web page including a smart bar;

FIG. 10B is an example of a user interface screen on a mobile app including a smart bar;

FIG. 11 is an example of a user interface screen including a product detail page;

FIG. 12 is an example of a user interface screen including an analytics user interface;

FIG. 13A is a flow chart illustrating method steps for an embodiment of a system according to an aspect of the disclosure;

FIG. 13B is a flow chart illustrating additional method steps;

FIG. 13C is a flow chart illustrating additional method steps; and

FIG. 13D is a flow chart illustrating additional method steps.

### DETAILED DESCRIPTION

Recurring features, elements, and structures are marked with identical reference numerals in the figures. A system and method for location-based product merchandising are disclosed.

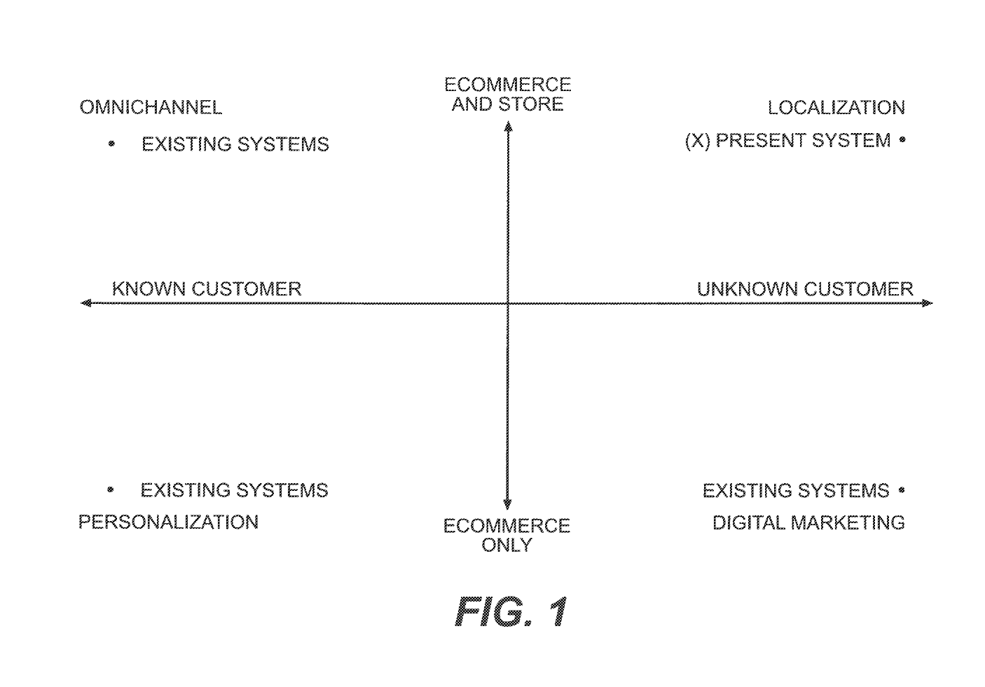

The diagram of FIG. 1 illustrates the landscape of different product merchandising systems, and how the system 10 of the present disclosure differs from existing systems available today. FIG. 1 is divided into four quadrants, with the vertical axis representing ecommerce only systems, that is, systems aimed toward facilitating sales through electronic means such as on an internet website and/or through a mobile application or “app”, vs. ecommerce and in-store merchandising. The horizontal axis represents merchandising aimed toward known consumers, that is, marketing based on known history and/or preferences of specific consumers, vs. merchandising aimed toward unknown consumers, not based on any history or preference data. Systems targeting “unknown” customers may deal with actual unknown customers, based, for example, on an interaction with an anonymous person. Systems may also be purposely agnostic to any user identification data, treating all users as “unknown,” which may be advantageous, for example, to prevent mistargeting a customer based on preferences or identity of a prior user on a shared device, such as a public computer terminal.

With continued reference to FIG. 1, the upper-left quadrant, labeled “Omnichannel,” includes services directed toward marketing products to known customers through both ecommerce and in-store channels. The lower-left quadrant, labeled “Personalization,” includes services directed toward marketing products toward known customers through only ecommerce channels and not in physical “brick and mortar” stores. The lower-right quadrant, labeled “Digital Marketing.” includes services directed toward marketing products toward unknown customers through only ecommerce channels and not in physical “brick and mortar” stores. The upper-right quadrant, labeled “Localization,” includes services directed toward marketing products toward unknown customers through both ecommerce channels in physical “brick and mortar” stores. Prior to the development of the system 10 of the present disclosure, no other services have operated in this area. In short, the system 10 of the present disclosure targets a market segment that has been ignored by systems and methods of the prior art.

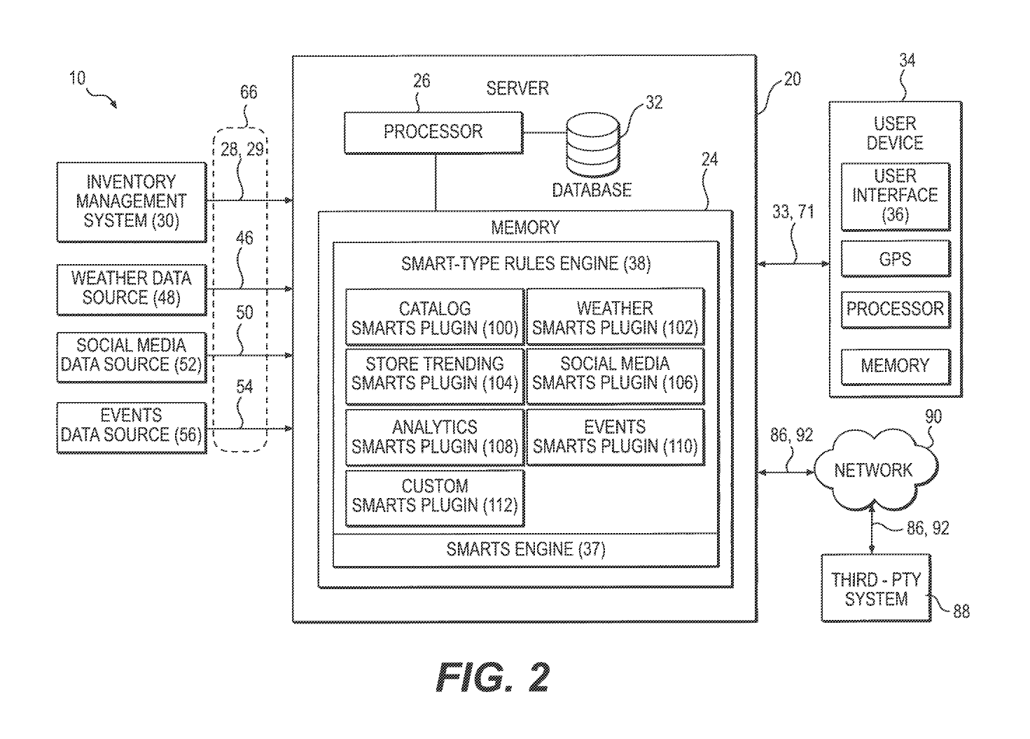

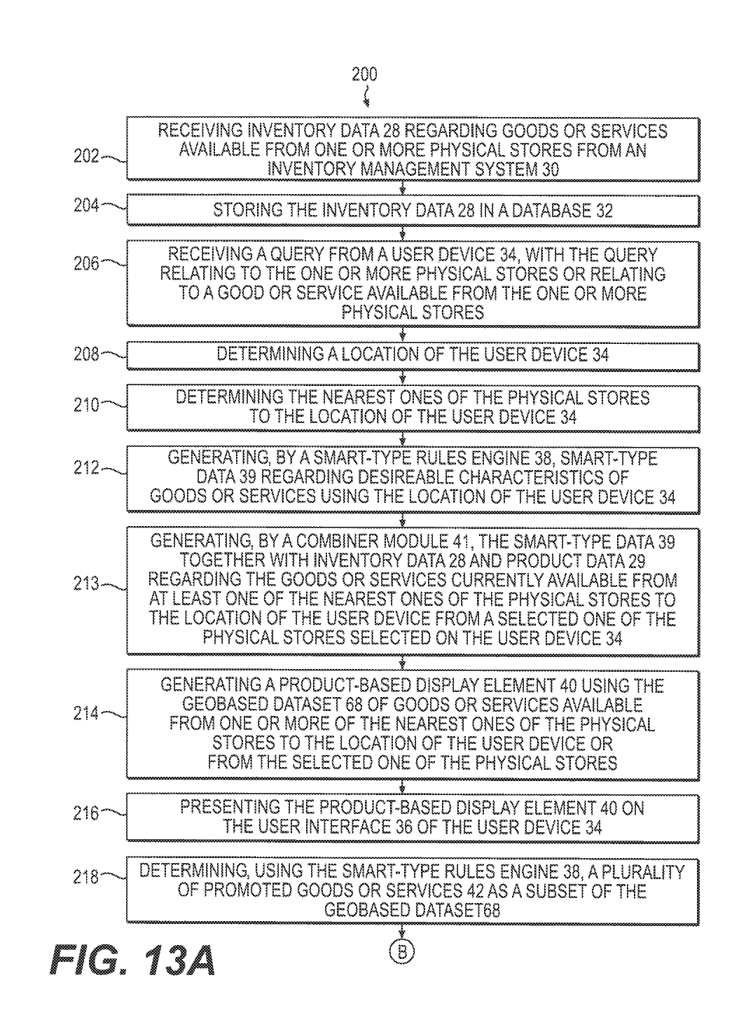

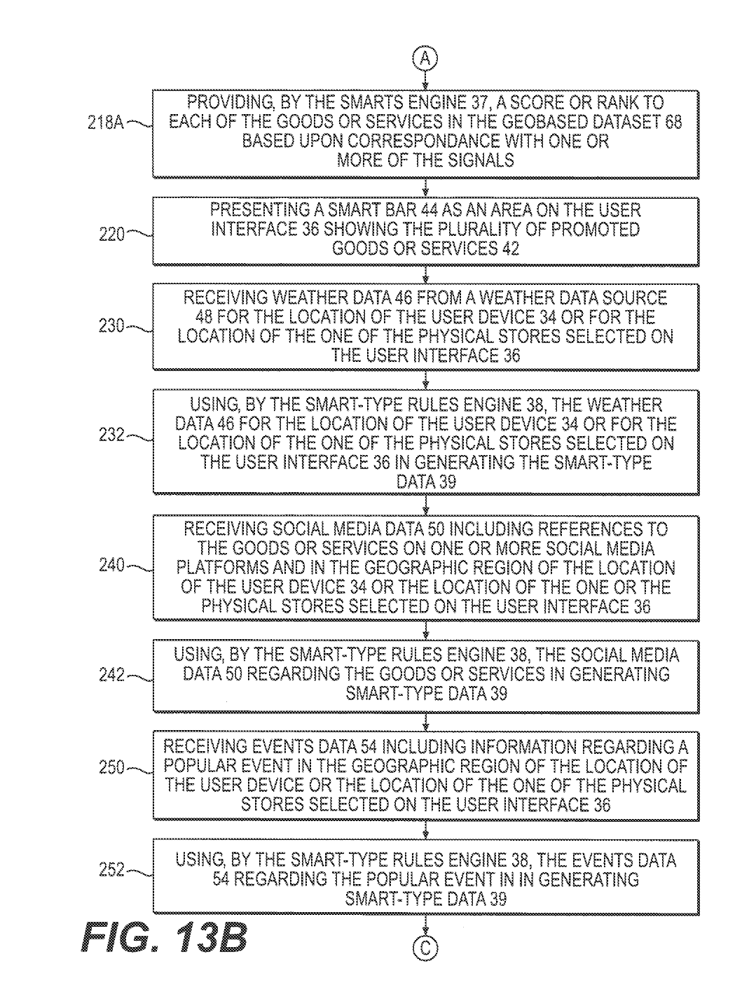

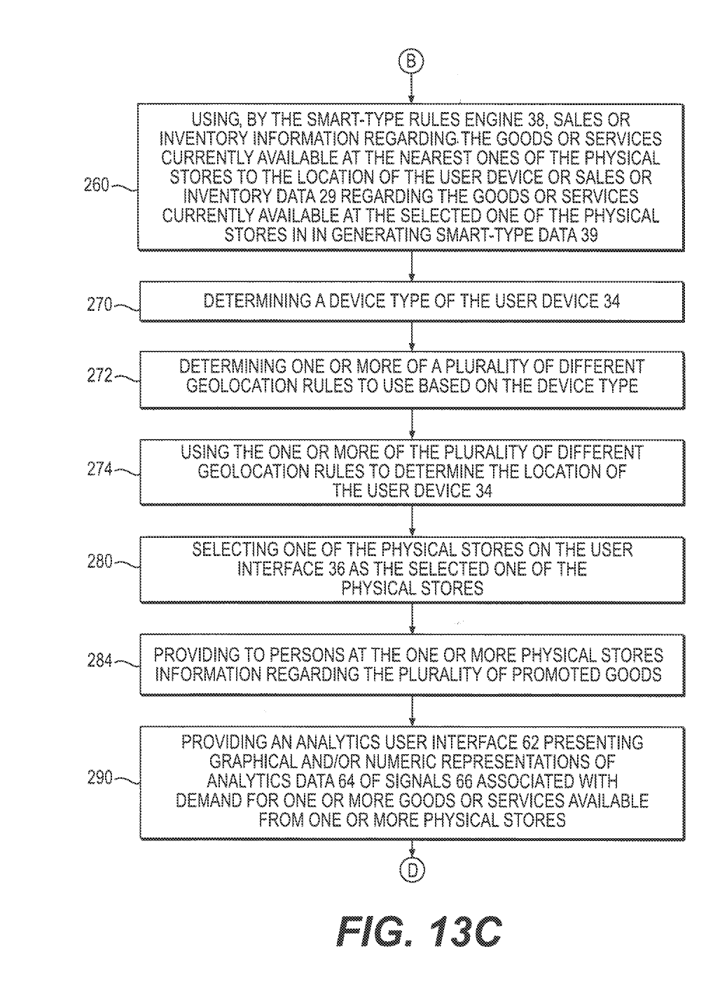

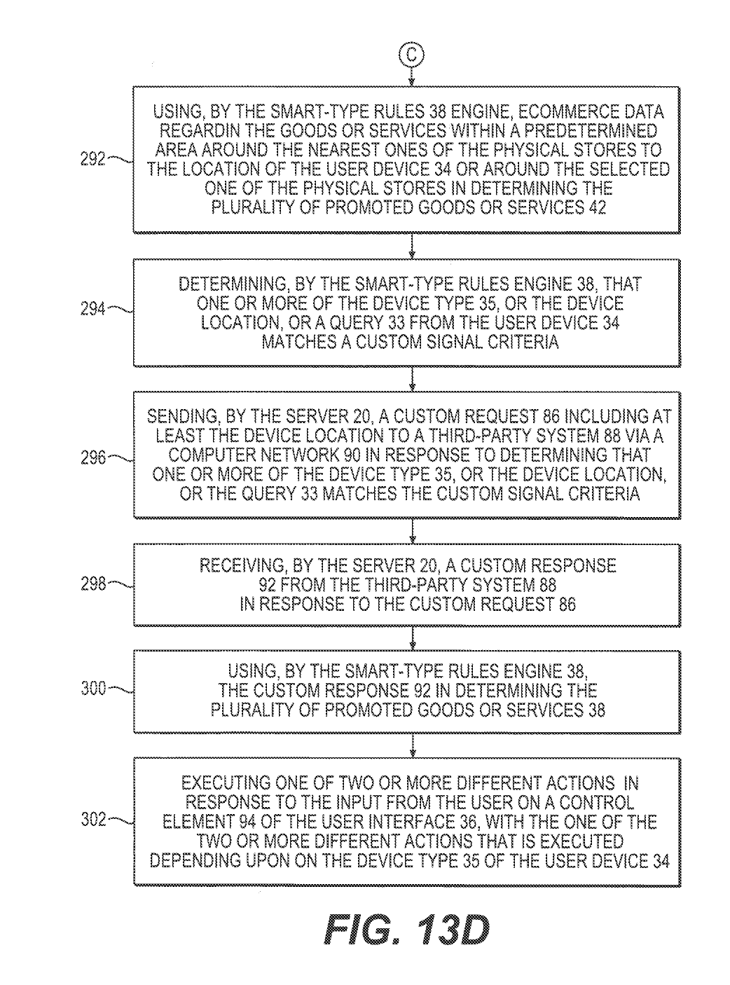

As shown in FIG. 2, a system 10 for location-based marketing according to exemplary embodiments of the disclosure preferably includes a server 20 including a computer-readable storage media 24 storing computer-executable executable instructions that, when executed by one or more processors 26, instruct a computing device to perform a plurality of actions corresponding with a method 200 for location-based product merchandising, as will be described in more detail below in connection with FIGS. 13A-13D. The computer-readable storage media 24 may include one or more memory devices such as RAM, ROM, Flash, magnetic or optical media, and may be provided onboard a processor 26, or a combination of devices. The system 10 of the present disclosure collects and analyzes various types of data including inventory data 28, product data 29, weather data, social media data 50, and events data 54. Those various types of data are collectively called signals 66, which are used to promote sales of goods or services in physical stores.

As also shown in FIG. 2, the system 10 includes a smart-type rules engine 38 including several different Plugins or modules, each providing associated processing or data presentation functionality. The smart-type rules engine 38 includes a catalog smarts plugin 100, which combines catalog type data regarding goods or services available from one or more physical stores, and which are tracked by an inventory management system 30. The catalog smarts plugin 100 may combine different versions of a product, such as different sizes, colors, etc. into a single listing with shared descriptive data, photos, etc. The smart-type rules engine 38 includes a weather smarts plugin 102, which parses weather data 46 and makes decisions regarding promoting or featuring specific products based on that weather data 46. The smart-type rules engine 38 also includes a store trending smarts plugin 104, which parses and analyzes sales data for products sold at one or more physical locations of a store to determine products that arc becoming more popular or less popular.

As also shown in FIG. 2, the smart-type rules engine 38 includes a social media smarts plugin 106, which parses social media data 50 to determine products that are popular or are associated with popular trends based on the social media data 50 such as mentions, hashtags, or positive endorsements, such as “likes.” The smart-type rules engine 38 also includes an analytics smarts plugin 108, which analyzes and formats various data collected, including promoted goods or services 42, and actual sales of individual products by geographic region, which may include one or more physical stores. The smart-type rules engine 38 also includes an event smarts plugin 110, which parses events data 54 regarding popular events happening near one or more of the physical stores, and which determines correlations between those popular events and one or more products sold by the physical stores. The smart-type rules engine 38 also includes a custom smarts plugin 112, which may parse and analyze one or more of the signals 66 based on one or more custom or user-defined rules.

As also shown in FIG. 2, the system 10 is in communication with a third-party system 88 via a computer network 90 for transmitting a custom request 86 and for receiving a custom response 92. This process is detailed below at steps 294 through 300 of the method 200.

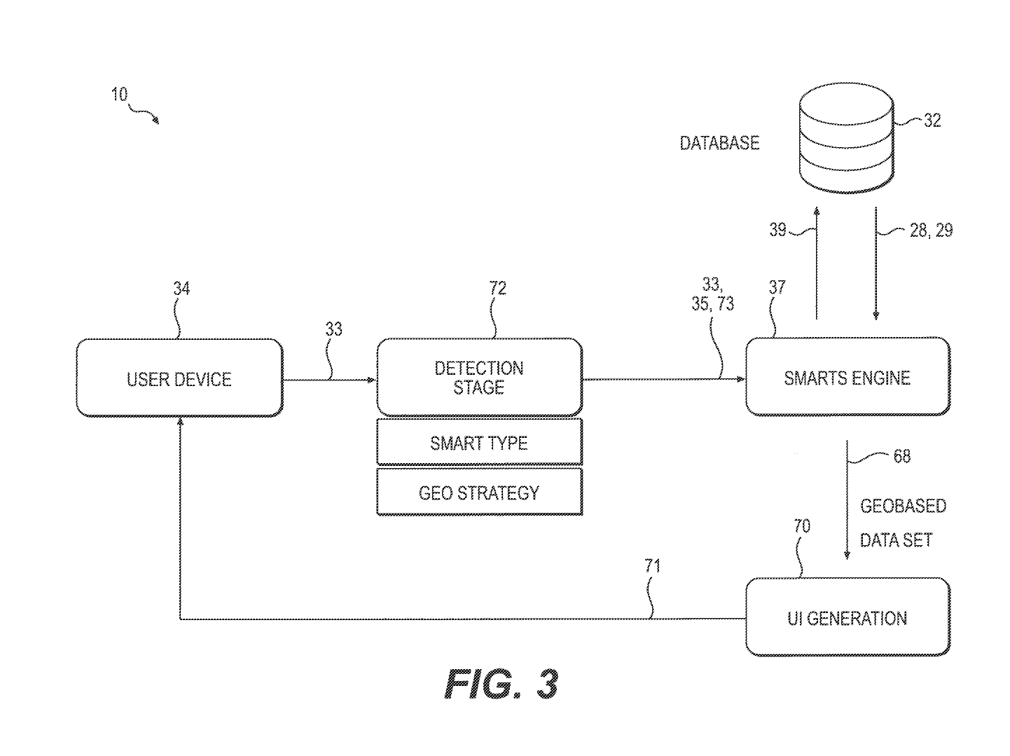

FIG. 3 is an overview diagram of components of the system 10 for location-based product merchandising of an example embodiment of the present disclosure. As illustrated in FIG. 3, the system 10 provides a cycle, taking a query 33 from the user device 34, and providing UI code 71 to the user device 34. As shown in FIG. 3, the system 10 includes a detection stage 72 for determining a device type 35 and location data 73 of the user device 34. The detection stage 72 and its operation are discussed in more detail below. The system 10 also includes a smarts engine 37, which takes the device type 35 and location data 73 of the user device 34, together with inventory data 28 and product data 29 from a database 32 and generates a geobased dataset 68, which is sent to a II engine 70. The smarts engine 37 also generates smart-type data 39, which is sent to the database 32 for storage. The UI engine 70 then uses the geobased dataset 68 to produce and send the UI code 71 to the user device 34, which is used for presenting a user interface 36 on the user device 34.

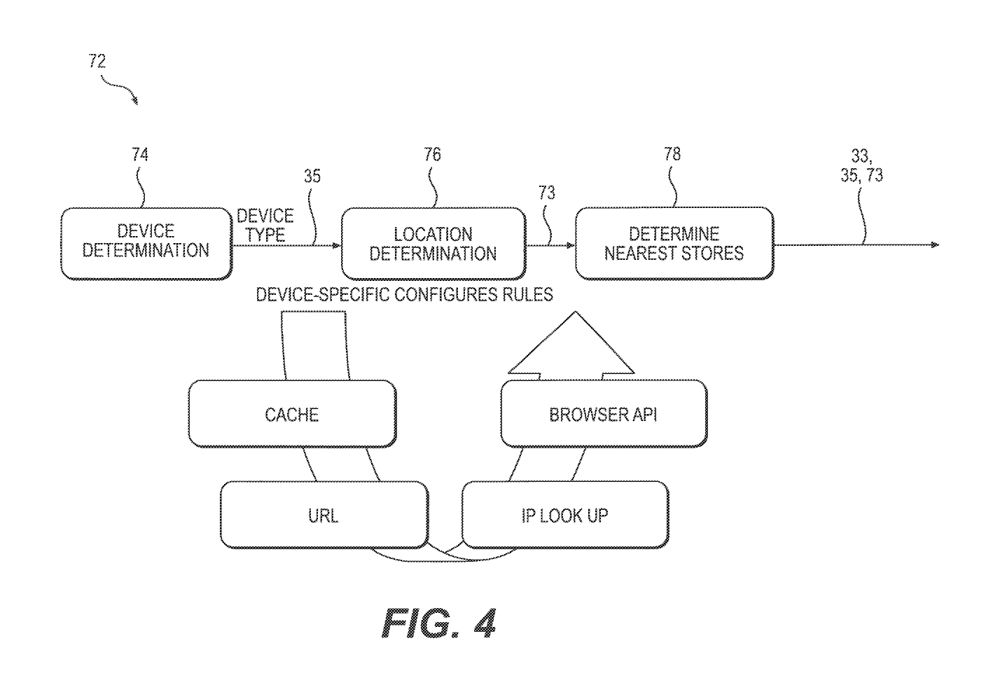

FIG. 4 is a block diagram showing details of the detection stage 72. As shown in FIG. 4, the detection stage 72 includes a device determination module 74 for determining the device type 35 of the user device 34. The operation of the device determination module 74 is detailed below at step 270 of the method 200. The detection stage 72 also includes a location determination module 76 for determining the location data 73 regarding the physical location of the user device 34. The detection stage 72 also includes a nearest-store module 78 for determining one or more of the physical stores in the vicinity of the user device based upon the location information 73. The operation of the location determination module 76 and the nearest-store module 78 are detailed below at step 274 of the method 200.

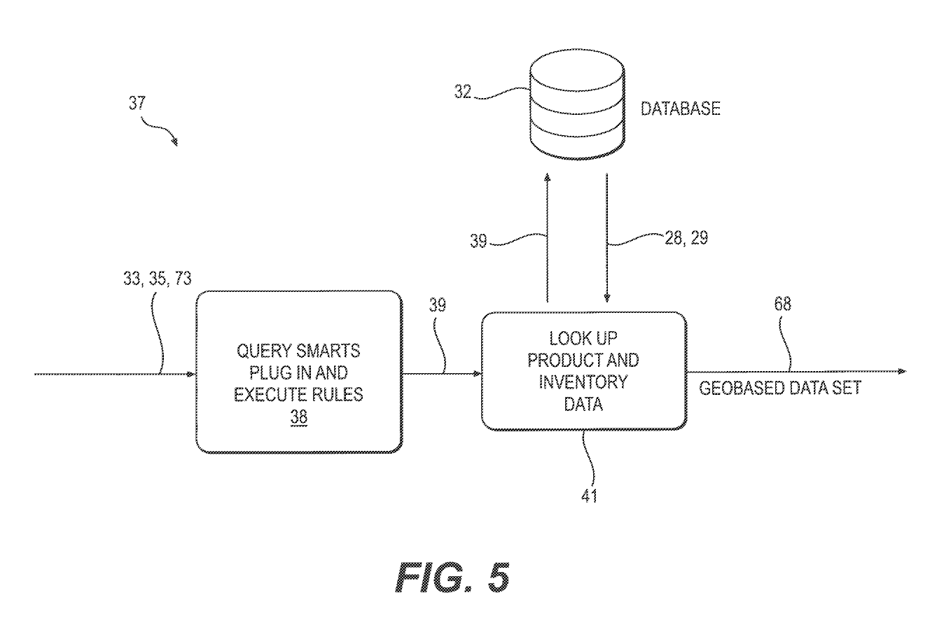

FIG. 5 is a block diagram showing details of the smarts engine 37 of the diagram of FIG. 3. FIG. 5 includes a smart-type rules engine 38, which takes the query 33, the device type 35, and the location data 73 about the user device 34 and executes rules configured in the system, along with any plugins that are relevant to the query 33, the device type 35, and the location data 73, and generates a smart type data 39. The operation of the smart-type rules engine 38 is detailed below at step 212 of the method 200. The smarts engine 37 also includes a combiner module 41, which takes the smart-type data 39, and combines it with inventory data 28 and product data 29 from the database 32 in order to generate a geobased dataset 68. The operation of the combiner module 41 is detailed below at step 213 of the method 200.

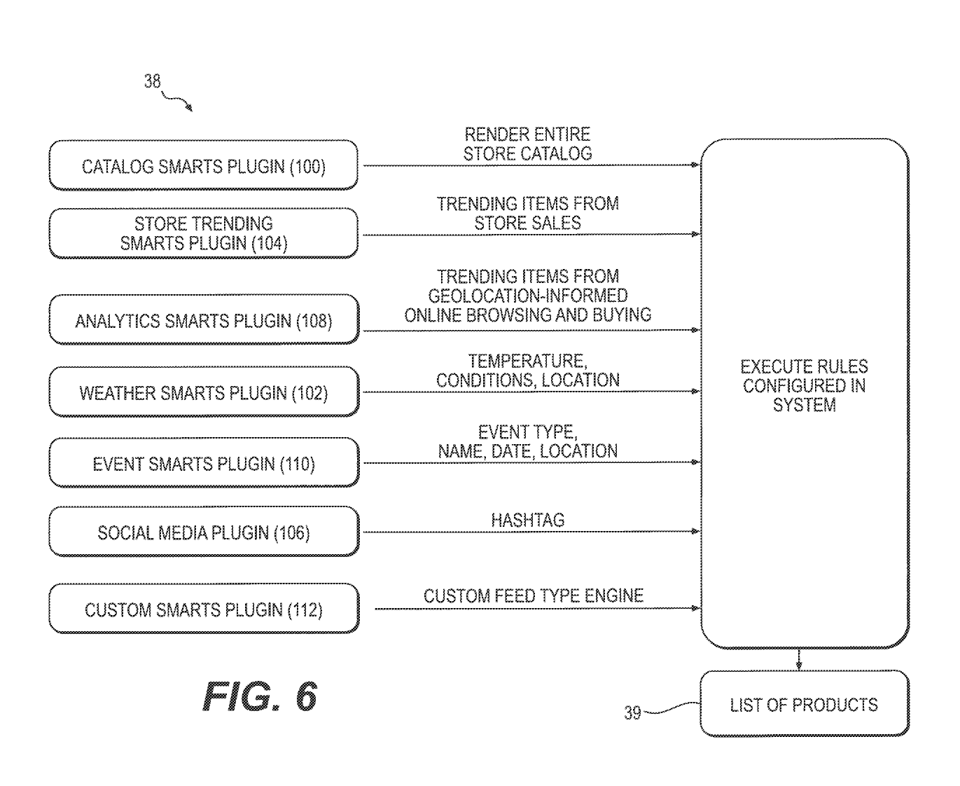

FIG. 6 is a block diagram of the smart-type rules engine 38 and its associated plugins 100, 102, 104, 110, 112, which together generate the smart-type data 39. The operation of the smart-type rules engine 38 in generating the smart-type data 39 is detailed below at step 212 of the method 200.

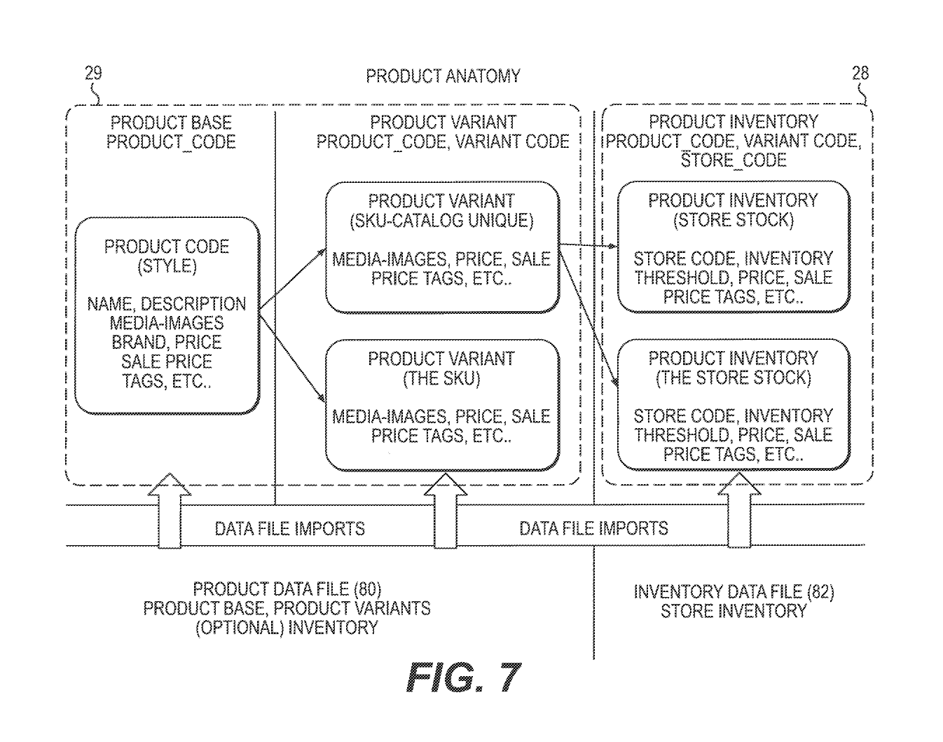

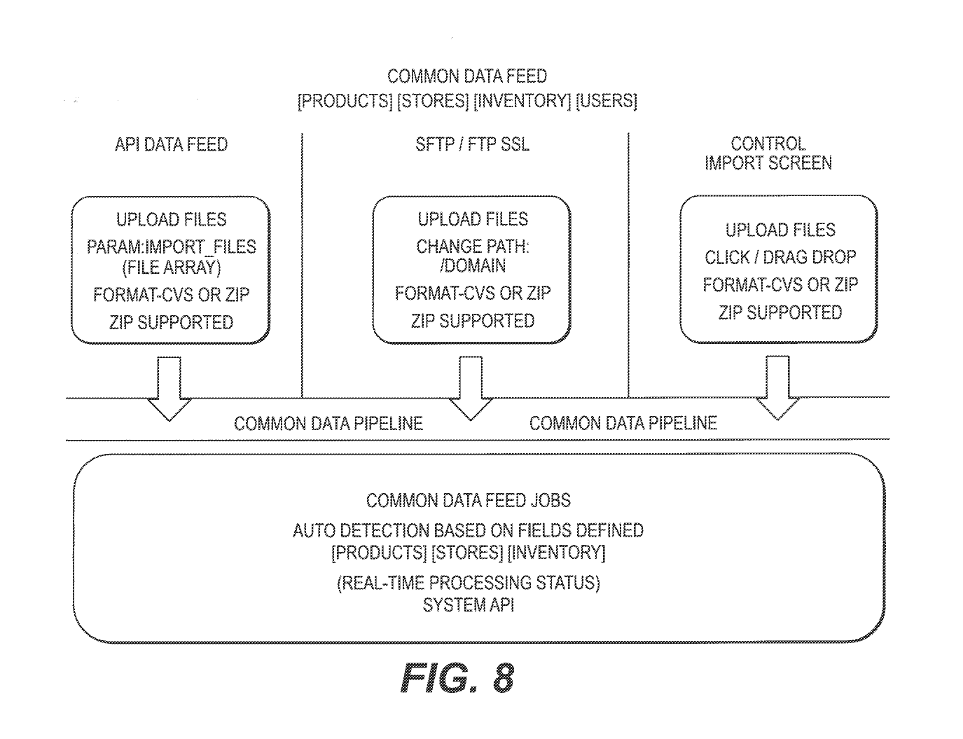

FIG. 7 shows an example embodiment of importing data files 80, 82, including a product data file 80 containing information regarding specific goods or services, and an inventory data file 82, containing information regarding store inventory. The store inventory may include information regarding stock and/or availability of the goods or services in one or more physical stores. As shown in FIG. 7, the system 10 obtains the product data 29 through one or more data file imports of the product data files 80. Likewise, the system 10 obtains the inventory data 28 through one or more data file imports of the inventory data files. In short, the data files 80, 82 provide the mechanism by which the system 10 obtains the inventory data 28 and the product data 29 from the inventory management system 30. However, the product data file 80 and the inventory data file 82 may each come from different sources, and/or be updated at different times or at different frequencies. For example, new product data files 80 may be provided only when the product data 29 is changed, which may be fairly infrequent, while the inventory data 28 may be updated much more regularly so the system 10 is kept up-to-date with the inventory in stock at each of the physical stores.

FIG. 8 shows an example embodiments of a data import portion of the system 10 for acquiring inventory data 28 and product data 29 from the inventory management system 30. Details regarding the operation of these components of the system 10 are described below as they are used to carry-out various associated method steps.

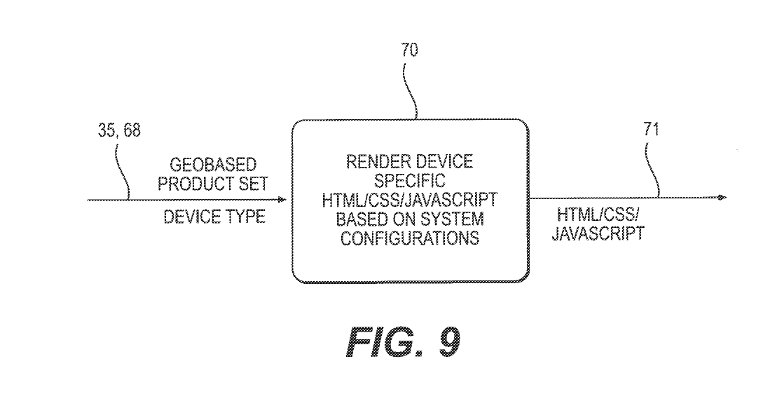

FIG. 9 snows details of the “UI GENERATION” portion of FIG. 3. This includes UI engine 70, which takes the device type 35 and the geobased dataset 68, and generates UI code 71. The operation of the UI engine 70 is detailed below at step 214 of the method 200.

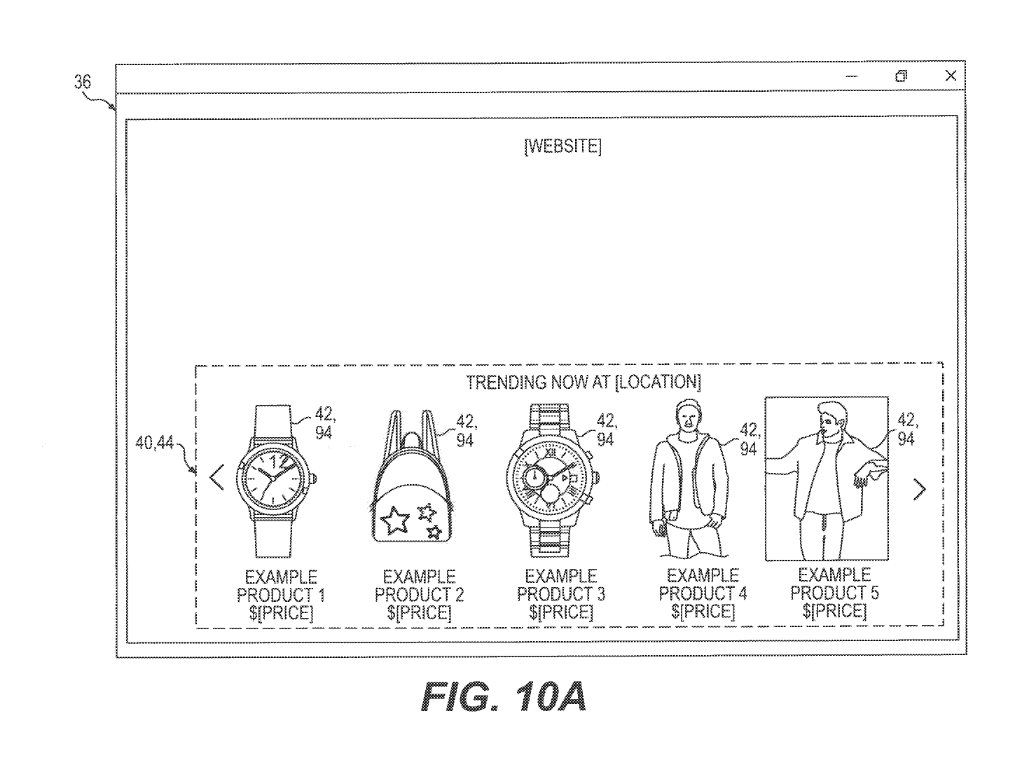

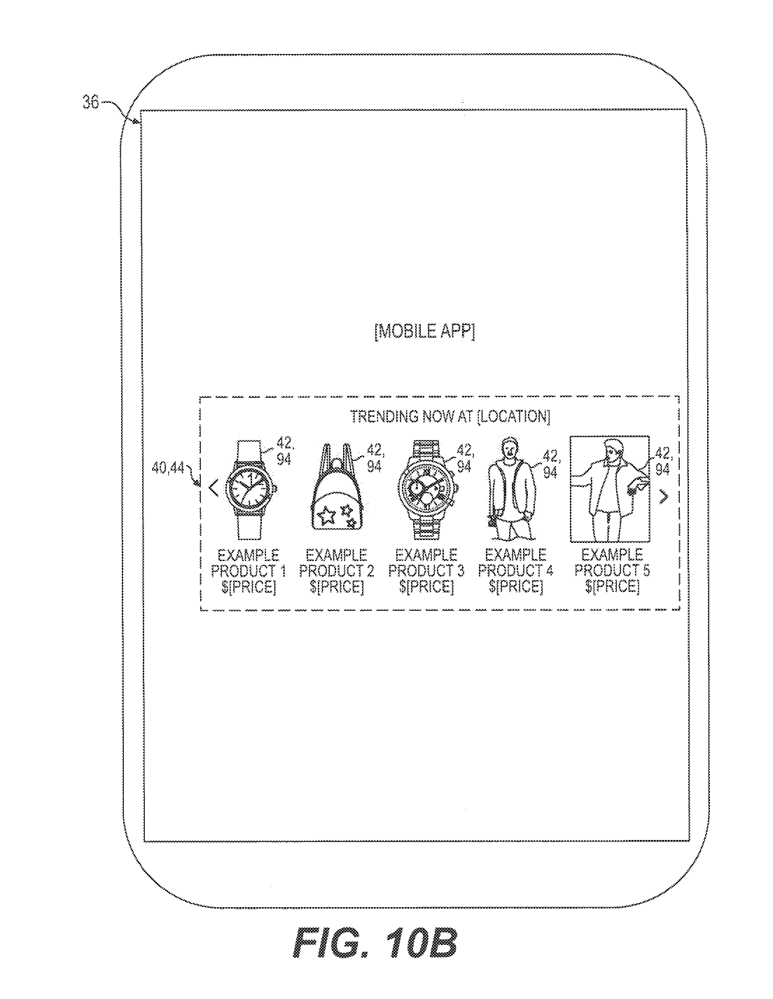

FIGS. 10A and 10B each include examples of a user interface 36 presented on the user device 34, and which includes a product-based display element 40 that is a smart bar 44 displaying several promoted goods or services 42. FIG. 10A shows the user interface 36 being a web site, which may be, for example, a store webpage, a page of results from a search engine, or a social media website. FIG. 10B shows the user interface 36 as an application or app on a mobile device such as a smart phone, which may be, for example, a shopping app, a social media app, an email app, or a web browser showing a web page tailored for viewing on a mobile device. Details regarding the choice of the promoted goods or services 42 to be included on the smart bar 44 are described below at step 218 of the method 200. Each of the promoted goods or services 42 shown on the smart bar 44 is a control element 94, which may be clicked or tapped by a user to invoke an action by the system 10, which may vary depending on the type of user device 34. This is described in detail below at step 302 of the method 200.

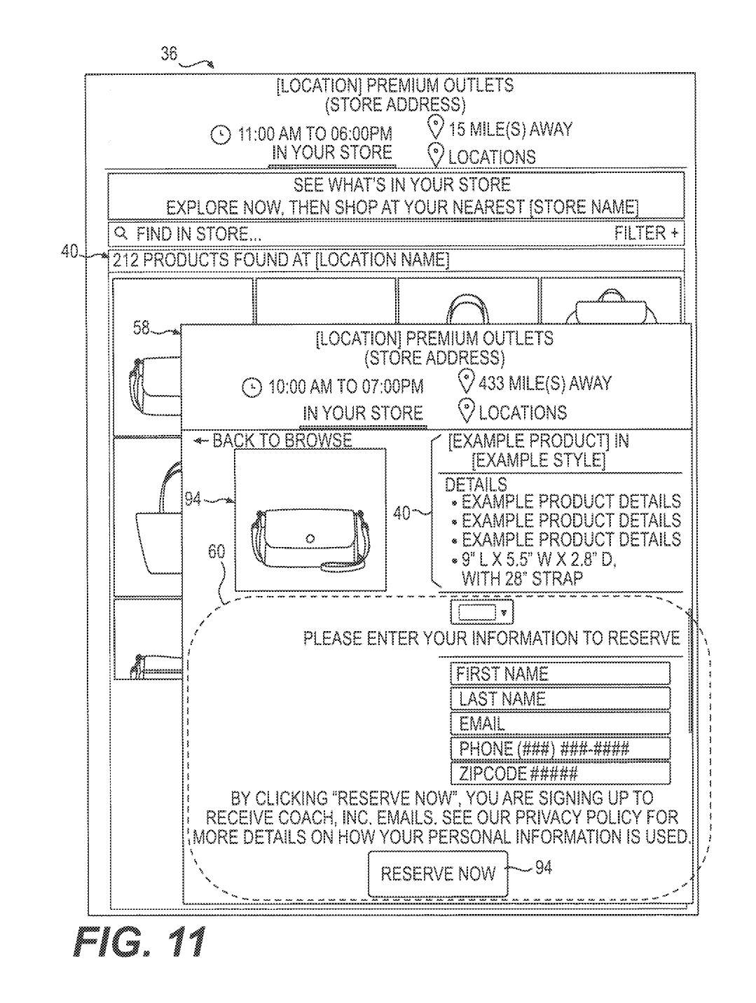

FIG. 11 is another example of a user interface 36 presented on the user device 34, and which includes a product-based display element 40 that is a product detail page 58 including information regarding a particular item in stock at the selected one of the physical stores. As also shown in FIG. 11, the product detail page 58 includes a reservation control 60 for reserving one or more of the particular item at the selected one of the physical stores for subsequent pickup. This reservation control 60, associated with the geobased dataset 68 of goods that are known to be in-stock at the selected one of the physical stores, may together me called a product description page (PDP) Reserve Widget. The PDP reserve widget provides benefits to retailers, by driving more store traffic by monetizing “intent to visit the store” on the store locator page by enabling the customer to easily pre-shop their visit.

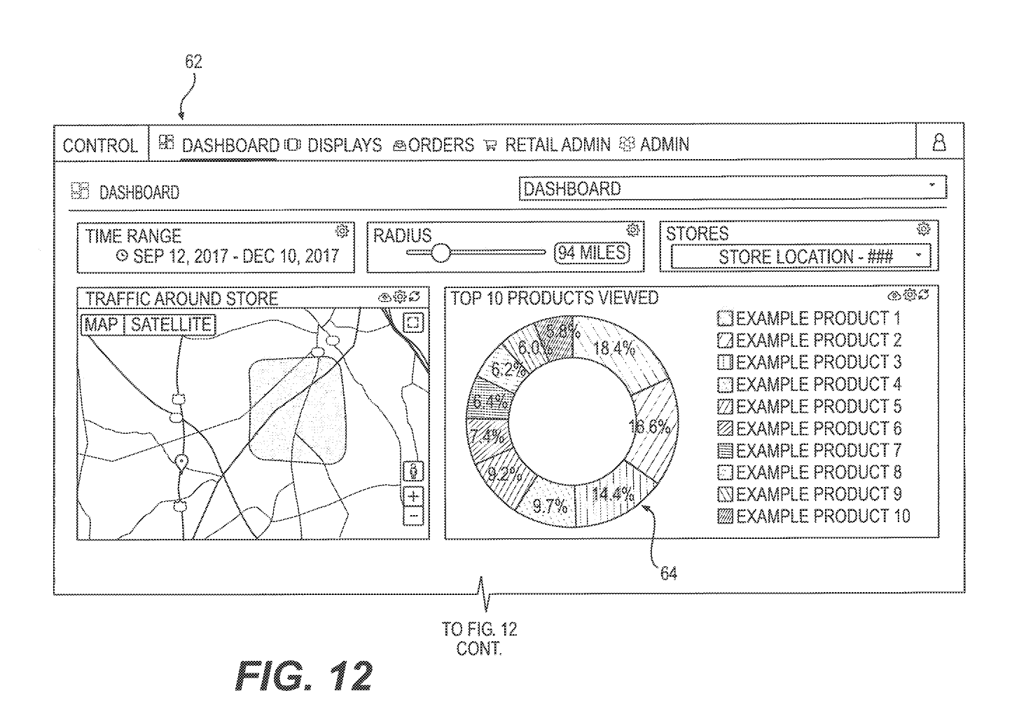

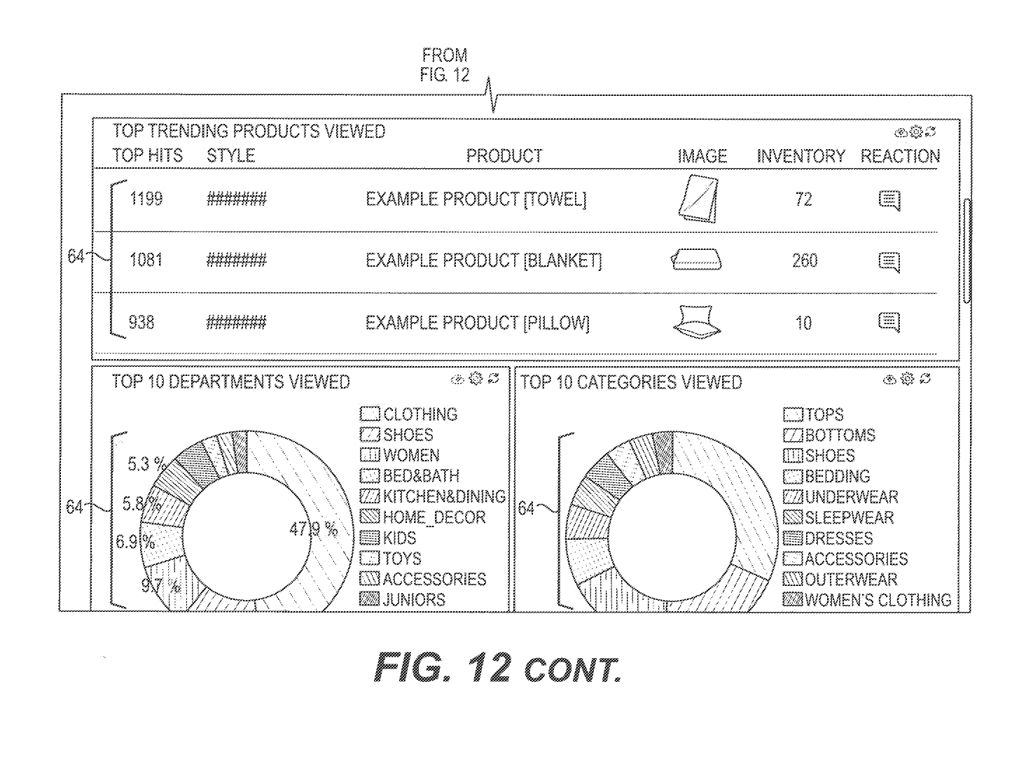

FIG. 12 is another example of a user interface 36 presented on the user device 34, and which includes an analytics user interface 62 presenting graphical and/or numeric representations of analytics data 64 of signals 66 associated with demand for one or more goods or services available from one or more physical stores.

As shown in the flow charts of FIGS. 13A, 13B, 13C, and 13D, the present disclosure includes a method 200 for location-based product merchandising. The method 200 includes receiving inventory data 28 and product data 29 regarding goods or services available from one or more physical stores from an inventory management system 30 at step 202. The inventory management system 30 may be a computerized system used for tracking inventory and/or sales data pertaining to the one or more physical stores, and may be used, for example, for automatically ordering replacement inventory, and/or for other business purposes such as tracking sales performance. The inventory data 28 may include, for example, information regarding the number of items of a particular product that are in stock at a given physical store location. The product data 29 may include, for example, pictures, descriptions, keywords, ratings, and other information regarding the products.

The method 200 also includes storing the inventory data 28 in a database 32 at step 204. The database 32 may be integrated with the server 20 as shown in FIG. 2. Alternatively or additionally, the database 32 may include one or more stand-alone or distributed storage devices which may be independent from the server 20. The database 32 may include data stored both locally within the server 20 and data stored externally from the server 20.

The method 200 also includes receiving a query 33 from a user device 34, with the query 33 relating to the one or more physical stores or relating to a good or a service available from the one or more physical stores at step 206. The user device 34 may be, for example, a smartphone, tablet, personal computer, or a kiosk type computer terminal. The user device 34 may include a user interface 36, which may be a graphical user interface (GUI) presented by one or more programs or “apps” and/or a web-based interface, such as a website or an e-mail message.

The method 200 also includes determining a location of the user device 34 at step 208. The specific details of this step are described in detail below at step 272.

The method 200 also includes determining the nearest ones of the physical stores to the location of the user device 34 at step 210. This may be done by computing an absolute distance, “as the crow flies” as the difference between the location of each of the physical stores and the location of the user device 34. Alternatively, this distance may be an actual travel distance, such as a driving distance over the best route, which may be provided by a mapping program or device, or by a service such as, for example, by Google maps.

The method 200 also includes generating, by a small-type rules engine 38, a smart-type data 39 regarding desirable characteristics of one or more goods or services using the location of the user device 34 at step 212. The smart-type data 39 may include, for example, keywords and other information based upon the signals 66 and/or based on the query 33 from the user, which can be used to determine specific products to present on the user interface 36. The desirable characteristics may include, for example, particular styles of clothing items that are currently popular in the area where the user device 34 is located. The desirable characteristics may also include correspondence with one or more signals 66, which may be determined by one or more plugins 100, 102, 104, 110, 112 of the smart-type rules engine 38.

The method also includes generating, by a combiner module 41, the geobased dataset 68 of goods or services by using the smart-type data 39, together with inventory data 28 and product data 29 regarding the goods or services currently available from at least one of the nearest ones of the physical stores to the location of the user device or from a selected one of the physical stores selected on the user device at step 213. Those specific ones of the physical stores may include one or more of the physical stores nearest to the location of the user device 34. The specific ones of the physical stores may alternatively or additionally include a selected one of the physical stores, selected on the user device 34, or one which was preset, such as a “home” store. For example, a user searching for items at a given clothing store chain from a user device 34 in downtown Chicago may be presented with information regarding clothing items stocked at one or more physical stores nearby in downtown Chicago. That user may select a physical store at a different location (e.g. in Atlanta) and then be presented with information regarding the clothing items stocked at that physical store in Atlanta.

The method 200 also includes generating a product-based display element 40 using the geobased dataset 68 of goods or services available from one or more of the nearest ones of the physical stores to the location of the user device 34 or from the selected one of the physical stores at step 214. This step may be performed by a UI engine 70, which may, for example, produce HTML, CSS, and/or Javascript user interface (UI) code, for a user interface that is web-based. As shown in FIG. 9, the rendering engine 70 may produce code for the user interface 36 that varies depending on the device type 35 of the user device 34. For example, the UI engine 70 may produce different UI code 71 for a user device 34 that is a smartphone vs. one that is a desktop personal computer. The UI engine 70 may be divided between the server 20 and the user device 34, with both working together to generate the user interface 36.

The method 200 further includes presenting the product based display element 40 on the user interface 36 of the user device 34 at step 216. The product-based display element 40 may include, for example, product description pages (PDP) with choices limited only to inventory on-hand or typically stocked at one or more of the nearest ones of the physical stores to the location of the user device 34 or at the selected one of the physical stores.

According to an aspect, the method 200 may also include determining, using the smart-type rules engine 38, a plurality of promoted goods or services 42 as a subset of the geobased dataset 68 of goods or services at step 218. The plurality of promoted goods or services 42 includes one or more of the promoted goods or services 42. This step 218 may include providing, by the smarts engine 37, a score or a rank to each of the goods or services in the geobased dataset 68 based upon how well each of the goods or services corresponds with one or more of the signals 66, shown at substep 218A. The smarts engine 37 may give additional weight to signals 66 that are shown to be indicative of increased sales at a given time and location. This score or ranking may then be used to determine the promoted goods or services 42, and particularly the ones of the promoted goods or services 42 shown on the smart bar 44, and the order that they are presented.

As illustrated in FIG. 13B, the method 200 preferably also includes presenting a smart bar 44 as an area on the user interface 36 showing the plurality of promoted goods or services 42 at step 220. This step may be performed by either the server 20 or by the user device 34, or by a combination of both the server 20 and the user device 34 together. An example of the user interface 36 including the smart bar 44 is shown on FIG. 10. The smart bar 44 may present a subset of all of the promoted goods or services 42 at any given time. For example, as shown on FIG. 10, the smart bar 44 may present five of the promoted goods or services 42 at once, and may provide scrolling arrows, allowing a user to cycle through additional ones of the promoted goods or services 42. In other words, the system 10 may provide for a larger number of promoted goods or services 42 than the number presented on the smart bar 44 at any given time. The smart bar 44 is a user interface element that may be any shape or configuration and is not limited to a “bar” shape. The smart bar 44 may be presented, for example, as a “sponsored content” type item, which may be presented in-line with other content. The smart bar 44 may be presented in any form or forms including, for example, graphic, textual, animated, or video forms. The smart bar 44 may present any number of the promoted goods or services 42 at any given time. The specific format of the smart bar 44 may vary depending on the device type 35, and/or the details of the user interface 36. For example, a smart bar 44 shown on a web browser of a personal computer may appear entirely different than a smart bar 44 that appears as in-line sponsored content within a social media feed of an app. on a mobile device.

As shown in FIG. 13B, the method 200 may include receiving weather data 46 from a weather data source 48 for the location of the user device 34 or for the location of the one of the physical stores selected on the user interface 36 at step 230. The weather data source 48 may include an internet-based source, such as, for example, from a website or data stream from the National Weather Service or from a commercial service. The weather data 46 may come from another weather data source 48 such as a radio or television broadcast. The method 200 may further include using, by the smart-type rules engine 38, the weather data 46 for the location of the user device or for the location of the one of the physical stores selected on the user interface 36 in generating the smart-type data 39 at step 232. For example, promoted goods or services 42 in stores located in areas experiencing a rain storm may include rain boots and umbrellas. For areas expecting a major storm such as a hurricane, promoted goods or services 42 may include generators, flashlights, bottled water, and the like.

According to another aspect, the method 200 may include receiving social media data 50 including references to the goods or services on one or more social media platforms and in the geographic region of the location of the user device 34 or the location of the one of the physical stores selected on the user interface 36 at step 240. The social media data 50 may come from one or more social media data sources 52, which may include accounts directly monitoring social networks, or from social media aggregation services that combine data from multiple different social networks to determine the relative popularity of various words or phrases.

The method 200 may further include using, by the smart-type rules engine 38, the social media data 50 regarding the goods or services in generating the smart-type data 39 at step 242. For example, a specific item of clothing may begin “trending” or being commonly discussed on social media in one or more geographic areas. Social media data 50 regarding that newly popular item may be used to promote that item, by, for example, featuring it and related items more prominently to users located in those geographic areas. Such featuring may be done on the user interface 36, in-store, and/or through other means such as through traditional marketing materials.

The method 200 may further include receiving events data 54 including information regarding a popular event in the geographic region of the location of the user device 34 or the location of the one of the physical stores selected on the user interface 36 at step 250. Popular events may include, for example, a concert, a concert tour, or a festival; a political event, such as a convention, election, or a rally; a sporting event, such as the Olympics, a race such as a NASCAR race, or a marathon, or a particular professional or amateur game, season, or tournament. Popular events may also include holiday events, such as, for example, a holiday parade or other celebration event, such as New Year's Eve in Times Square, New York. Another example of a popular event is spring break at specific beach destination locations and/or for store locations around colleges and universities. As illustrated in FIG. 2. The system 10 may receive the events data 54 from one or more events data sources 56, such as from Ticketmaster, Stub-Sub, or other data aggregation services that can provide information regarding specific popular events, and associated dates, times, and locations.

The method 200 may also include using, by the smart-type rules engine 38, the events data 54 regarding the popular event in generating the smart-type data 39 at step 252. This may include, for example, promoting music and/or clothing featuring a particular artist or group for a period of several days or weeks up to and after a concert featuring that artist or group near the subject location.

As illustrated in FIG. 13C, the method 200 may further include using, by the smart type rules engine 38, sales or inventory information regarding the goods or services currently available at the nearest ones of the physical stores to the location of the user device 34 or sales or inventory data 29 regarding the goods or services currently available at the selected one of the physical stores in generating the smart-type data 39 at step 260. For example, the system 10 may include in the promoted goods or services 42, products that are top sellers, or ones that are recently abnormally popular (i.e. products that are trendy). As another example, the system 10 may include in the promoted goods or services 42, products that are particularly slow sellers, which may help to sell inventory that may be slow to sell because customers are not aware of their availability. As another example, the system may include in the promoted goods or services 42, products that are scarce, along with a message regarding the scarcity, e.g. “only 3 XYZ widgets left at the downtown store location”. Such messages may promote sales through a “fear of missing out” mindset by users of the system 10.

As also shown in FIG. 13C, the method 200 may further include determining a device type 35 of the user device 34 at step 270. The device type 35 may include a broad type (i.e. smartphone or personal computer), as well as specific information such as operating system type and version, browser type and version, type of network used for internet access such as, for example, Wi-Fi, broadband, or cellular data, and IP address of the user device 34. The device type 35 may include a general classification, such as whether the user device 34 is an in-store display or kiosk, or if it is a personal computer or a mobile device. This step is illustrated in the diagram of FIG. 4.

The method 200 may also include determining one or more of a plurality of different geolocation rules to use based on the device type 35 at step 272. For example, in response to having determined the user device 34 of having a device type 35 of a P.C. running Internet Explorer on Windows 10, the system 10 may he configured to use an IP lookup first, and then a browser API as a secondary means of determining the location. For a user device 34 that is an iPhone running iOS 11, the system 10 may be configured to use a browser API first, and then a system cache as a secondary means of determining the location of the user device 34. The system cache and/or browser API may employ location services of the user device 34, and may obtain location data from one or more sources including, for example, global positioning system (GPS), sensing nearby Wi-Fi networks, and/or relative strength of radio communications with one or more cellular infrastructure, e.g. cellular towers. If present, a URL tag may override any location determined by the user device 34. For example, the system 10 may be accessed from an internet uniform resource locator (URL) as a string of characters having a location coded therein (i.e. a URL tag). The system 10 would then use that tagged location as the location of the user device 34 and not perform any additional geolocation. This may allow, for example, for testing and/or for directing users to a specific location-based experience regardless of their current physical location. This step is illustrated in the diagram of FIG. 4.

The method 200 may also include using the one or more of the plurality of different geolocation rules to determine the location data 73 regarding the location of the user device 34 at step 274. This step 274 may be performed by the location determination module 76. This step 274 also includes interpreting the location data 73 available from the one or more of a plurality of different geolocation rules, which may include latitude longitude, zip code, city/state, a particular address, etc. into a common format, and for determining the one or more of the closest ones of the physical stores which match the query 33 from the user device 34, and for which the system 10 has information. This function is preferably performed by the nearest-store module 78. The query 33 may relate to general types of stores such as, for example, “shoe stores” or “hardware stores” or “hair salons.” Alternatively, the query 33 may relate to specific stores such as “XYZ shoe store.”

The method 200 may also include selecting one of the physical stores on the user interface 36 as the selected one of the physical stores at step 280. In response to the user having selected one of the physical stores on the user interface in step 280, the step of 214, generating a product based display element, may be limited to including using only the geobased dataset 68 of goods or services associated with the selected one of the physical stores.

The method 200 may also include providing to persons at one or more of the physical stores information regarding a plurality of promoted goods or services 42 as a subset of the geobased goods at step 284. For example, the system 10 may provide periodic recommendations to in-store employees regarding the promoted goods or services 42. The system 10 may also provide direct marketing and/or dynamic in-store displays based on the promoted goods or services 42.

The method 200 may also include providing an analytics user interface 62 presenting graphical and/or numeric representations of analytics data 64 of signals 66 associated with demand for one or more goods or services available from one or more physical stores at step 290. An example of the analytics user interface 62 is illustrated in FIG. 12. The presented analytics data 62 is associated with the location of the one or more physical stores. The signals 66 may include one or more of: weather data 46, social media data 50, or events data 54 regarding a popular event in the geographic area of the one or more physical stores. The signals 66 also include inventory data 28 and/or corresponding sales data from the one or more physical stores.

As shown in FIG. 13D, the method 200 may include using, by the small-type rules 38 engine, ecommerce data regarding the goods or services within a predetermined area around the nearest ones of the physical stores to the location of the user device 34 or around the selected one of the physical stores in determining the plurality of promoted goods or services 42 at step 292. The ecommerce data may include, for example, goods or services with the most clicks, least clicked, top purchased, least purchased, high conversion rates, and/or low conversion rates. This ecommerce data may be provided by one or more different sources, such as from the inventory management system 30 or another data source associated with a specific partner company that manages one or more of the physical stores. This ecommerce data may also be provided by one or more third party sources such as an aggregator of industry data.

The method 200 may also include determining, by the smart-type rules engine 38, that one or more of the device type 35, or the device location, or a query 33 from the user device 34 matches a custom signal criteria at step 294. This step 294 may he performed by the custom smarts plugin 112. The custom signal criteria may include, for example, specific reference to a store associated with the third party system 88, such as for a query 33 that references “XYZ shoe store”. The custom signal criteria may include, for example, a general reference to a store associated with the third party system 88, combined with the device location meeting predetermined requirements, such as for a query 33 that references “shoe stores,” and with the device location being within 20 miles of a physical location of XYZ shoe store.

The method 200 may also include sending, by the server 20, a custom request 86 including at least the device location to a third-party system 88 via a computer network 90 in response to determining that one or more of the device type 35, or the device location, or the query 33 matches the custom signal criteria at step 296.

The method 200 may also include receiving, by the server 20, a custom response 92 from the third-party system 88 in response to the custom request 86 at step 298.

The method 200 may also include using, by the smart-type rules engine 38, the custom response 92 in determining the plurality of promoted goods or services 38 at step 300.

Steps 294 through 300 together function to allow third-party integration into the subject system 10. For example, the custom smarts plugin 112 may allow the subject system 10 to generate the smart-type data 39 using a stand-alone promo engine or some other merchandising or business intelligence (BI) engine that is separate from the subject system 10. That smart-type data 39 may then be cross-checked against particular geobased dataset 68 can then be checked against inventory data 28 and/or product data 29 to generate a geobased dataset 68. This step may be performed by the combiner module 41, as described above at step 213.

As also shown on FIG. 13D, the method 200 may further include executing, at step 302, one of two or more different actions in response to the input from the user on a control element 94 of the user interface 36, with the specific action that is executed depending upon on the device type 35 of the user device 34. For example, a presentation of product information regarding a particular item on a user interface 36 of a personal computer may be clickable and direct to a shopping cart for ordering the particular item. A similar presentation of product information on a mobile app may be tappable to present the reservation control 60, allowing the user to reserve one or more of the particular item at a selected one of the physical stores for subsequent pickup. A similar presentation on of product information on an in-store display may be tappable to reveal more details about the product. The device type 35 of the user device 34 used in performing this step 302 may be determined as described above at step 270.

The system, methods and/or processes described above, and steps thereof; may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims.

What is claimed is:

1. A method for location-based product merchandising comprising:
storing, in a database, inventory data regarding goods or services available from one or more physical stores;
receiving a query from a user device presenting a user interface, with the query relating to the one or more physical stores or relating to a good or a service available from the one or more physical stores;
determining a location of the user device;
determining the nearest ones of the physical stores to the location of the user device;
determining, using the location of the user device, a geobased dataset of goods or services currently available from at least one of the nearest ones of the physical stores to the location of the user device or from a selected one of the physical stores selected on the user device;
generating a product-based display element using the geobased dataset of goods or services available from one or more of the nearest ones of the physical stores to the location of the user device or from the selected one of the physical stores; and
presenting the product-based display element on the user interface of the user device.

2. The method according to claim 1, further including:
generating, by a smart-type rules engine, using the location of the user device, a smart-type data regarding desirable characteristics of one or more goods or services;
generating, by a combiner module, the geobased dataset of goods or services by using the smart-type data together with inventory data and product data regarding the goods or services currently available from at least one of the nearest ones of the physical stores to the location of the user device or from a selected one of the physical stores selected on the user device; and
presenting a smart bar as an area on the user interface showing a plurality of promoted goods or services from the geobased dataset of goods or services.

3. The method according to claim 2, further including:
receiving weather data for the location of the user device or for the location of the one of the physical stores selected on the user interface; and
using, by the smart-type rules engine, the weather data for the location of the user device or for the location of the one of the physical stores selected on the user interface in determining the plurality of promoted goods or services.

4. The method according to claim 2, further including:
receiving social media data including references to the goods or services on one or more social media platforms and in the geographic region of the location of the user device or the location of the one of the physical stores selected on the user interface;
using, by the smart-type rules engine, the social media data regarding the goods or services in determining the plurality of promoted goods or services.

5. The method according to claim 2, further including:
receiving information regarding a popular event in the geographic region of the location of the user device or the location of the one of the physical stores selected on the user interface;
using, by the smart-type rules engine, the information regarding the popular event in determining the plurality of promoted goods or services.

6. The method according to claim 5, wherein the popular event includes at least one of a concert, a festival, a political event, a sporting event, or a holiday event.

7. The method according to claim 2, further including using, by the smart-type rules engine, sales or inventory information regarding the goods or services currently available at the nearest ones of the physical stores to the location of the user device or sales or inventory information regarding the goods or services currently available at the selected one of the physical stores in determining the plurality of promoted goods or services.

8. The method according to claim 2, further including using, by the small-type rules engine, ecommerce data regarding the goods or services within a predetermined area around the nearest ones of the physical stores to the location of the user device or around the selected one of the physical stores in determining the plurality of promoted goods or services.

9. The method according to claim 2, further including:
determining, by the smart-type rules engine, that one or more of the device type, or the device location, or the query matches a custom signal criteria;
sending, by the server, a custom request including at least the device location to a third-party system via a computer network in response to determining that one or more of the device type, or the device location, or the query matches the custom signal criteria;
receiving, by the server, a custom response from the third-party system in response to the custom request;
using, by the smart-type rules engine, the custom response in determining the plurality of promoted goods or services,

10. The method according to claim 1, further including:
determining a device type of the user device;
determining one or more of a plurality of different geolocation rules to use based on the device type; and
using the one or more of the plurality of different geolocation rules to determine the location of the user device.

11. The method according to claim 1, wherein the user interface of the user device includes a control element for accepting an input from a person using the user device, and wherein the method further includes:
determining a device type of the user device;
executing one of two or more different actions in response to the input from the user on the control element, wherein the one of the two or more different actions that is executed depends upon on the device type of the user device.

12. The method according to claim 1, further including:
selecting one of the physical stores on the user interface as the selected one of the physical stores; and
wherein the step of generating a product-based display element includes using only the geobased dataset of goods or services associated with the selected one of the physical stores.

13. The method according to claim 1, wherein the product-based display element includes a product detail page including information regarding a particular item in stock at the selected one of the physical stores; and
wherein the product detail page includes a control for reserving one of the particular item at the selected one of the physical stores for subsequent pickup.

14. The method according to claim 1, further including:
generating, by a smart-type rules engine, using the location of the user device, a smart-type data regarding desirable characteristics of goods or services;
generating, by a combiner module, the geobased dataset of goods or services by using the smart-type data together with inventory data and product data regarding the goods or services currently available from at least one of the nearest ones of the physical stores to the location of the user device or from a selected one of the physical stores selected on the user device; and
providing to persons at one or more of the physical stores, information regarding a plurality of promoted goods as a subset of the geobased dataset.

15. The method according to claim 1, further including:
providing an analytics user interface presenting analytics data of signals associated with demand for one or more goods or services available from one or more physical stores;
wherein the analytics data is associated with the location of the one or more physical stores; and
wherein the signals include one or more of weather data, social media data, sales performance at the one or more physical stores, or information regarding a popular event in the geographic area of the one or more physical stores; and
wherein the signals include sales or inventory data from the one or more physical stores.

16. A method for location-based marketing comprising:
storing, in a database, inventory data regarding goods or services available from one or more physical stores;
determining a location of a user device including a user interface;
determining one or more nearest ones of the physical stores to the location of the user device;
determining, using the location of the user device, a geobased dataset of goods or services currently available from at least one of the nearest ones of the physical stores to the location of the user device or from a selected one of the physical stores selected on the user device;
generating a product-based display element using the geobased dataset of goods or services;
presenting the product-based display element including a smart bar as an area on the user interface showing a plurality of promoted goods or services as a subset of the geobased dataset of goods or services

17. The method according to claim 16, further including:
receiving weather data for the location of the user device or for the location of the one of the physical stores selected on the user interface; and
using, by the smart-type rules engine, the weather data for the location of the user device or for the location of the one of the physical stores selected on the user interface in determining the plurality of promoted goods or services.

18. The method according to claim 16, further including:
receiving social media data including references to the goods or services on one or more social media platforms and in the geographic region of the location of the user device or the location of the one of the physical stores selected on the user interface;
using, by the smart-type rules engine, the social media data regarding the goods or services in determining the plurality of promoted goods or services.

19. The method according to claim 16, further including:
receiving information regarding a popular event in the geographic region of the location of the user device or the location of the one of the physical stores selected on the user interface;
using, by the smart-type rules engine, the information regarding the popular event in determining the plurality of promoted goods or services.

20. The method according to claim 19, wherein the popular event includes at least one of a concert, a festival, a political event, a sporting event, or a holiday event.

21. The method according to claim 16, further including using, by the smart-type rules engine, sales or inventory information regarding the goods or services currently available at the nearest ones of the physical stores to the location of the user device or sales or inventory information regarding goods or services currently available at the selected one of the physical stores in determining the plurality of promoted goods or services.

22. The method according to claim 16, further including using, by the smart-type rules engine, ecommerce data regarding the goods or services within a predetermined area around the nearest ones of the physical stores to the location of the user device or around the selected one of the physical stores in determining the plurality of promoted goods or services.

23. The method according to claim 16, further including:
determining, by the smart-type rules engine, that one or more of the device type, or the device location, or a query from the user device matches a custom signal criteria;
sending, by the server, a custom request including at least the device location to a third-party system via a computer network in response to determining that one or more of the device type, or the device location, or the query matches the custom signal criteria;
receiving, by the server, a custom response from the third-party system in response to the custom request;
using, by the smart-type rules engine, the custom response in determining the plurality of promoted goods or services.

24. The method according to claim 16, wherein the user interface of the user device includes a control element for accepting an input from a person using the user device, and wherein the method further includes:
determining a device type of the user device;
executing one of two or more different actions in response to the input from the user on the control element, wherein the one of the two or more different actions that is executed depends upon on the device type of the user device.

25. A system for location-based marketing of goods or services including one or more computer-readable storage media storing computer-executable executable instructions that, when executed by one or more processors, instruct a computing device to perform actions comprising:
storing in a database, inventory data regarding goods or services available from one or more physical stores;
receiving a query from a user device presenting a user interface, with the query relating to the one or more physical stores or relating to a good or service available from the one or more physical stores;
determining a location of the user device;
determining the nearest ones of the physical stores to the location of the user device;
determining a geobased dataset of goods or services currently available from at least one of the nearest ones of the physical stores to the location of the user device or from a selected one of the physical stores selected on the user device;
generating a product-based display element using the geobased dataset of goods or services associated with one or more of the nearest ones of the physical stores to the location of the user device or associated with the selected one of the physical stores;
presenting the product based display element on the user interface of the user device.

26. The system for location-based marketing of goods or services according to claim 19, wherein the one or more computer-readable storage media storing computer-executable executable instructions that, when executed by the one or more processors, instruct the computing device to perform actions further includes:
generating, by a smart-type rules engine, using the location of the user device, smart-type data regarding desirable characteristics of goods or services;
generating, by a combiner module, the geobased dataset of goods or services by using the smart-type data together with inventory data and product data regarding the goods or services currently available from at least one of the nearest ones of the physical stores to the location of the user device or from a selected one of the physical stores selected on the user device; and
presenting a smart bar as an area on the user interface showing a plurality of promoted goods or services from the geobased dataset of goods or services.
